(19) United States
(12) Patent Application Publication
(10) Pub. No.: US 2002/0191800 A1
(43) Pub. Date: Dec. 19, 2002

(54) In-situ transducer modeling in a digital hearing instrument

(76) Inventor: Stephen W. Armstrong, Burlington (CA)

Correspondence Address: Joseph M. Sauer, Esq., Jones, Day, Reavis & Pogue, North Point, 901 Lakeside Avenue, Cleveland, OH, 44114, US

(21) Appl. No.: 10/125,663

(22) Filed: Apr. 18, 2002

Related U.S. Application Data
(60) Provisional application No. 60/284,984, filed on Apr. 19, 2001.

(51) Int. Cl. H04R 29/00

(52) U.S. Cl. 381/60

(57) ABSTRACT

A method for in-situ transducer modeling in a digital hearing instrument is provided. In one embodiment, a personal computer is coupled to a processing device in the digital hearing instrument and configures the processing device to operate as a level detector and a tone generator. An audio signal generated by the personal computer is received by a microphone-under-test (MUT) in the digital hearing instrument and the energy level of the received audio signal is determined by the level detector. In addition, an audio output signal generated by the tone generator and a speaker-under-test (SUT) in the digital hearing instrument is received by a microphone, and the energy level of the audio output signal is determined by a level meter. The energy levels of the received audio signal and the audio output signal are used by the personal computer to generate an electro-acoustic model of the digital hearing instrument.

### CROSS-REFERENCE TO RELATED APPLICATION

This application claims priority from and is related to the following prior application: In-Situ Transducer Modeling In a Digital Hearing Instrument, U.S. Provisional Application No. 60/284,984, filed Apr. 19, 2001. In addition, this application is related to the following co-pending application which is owned by the assignee of the present invention: Digital Hearing Aid System, United States Patent Application [application number not yet available], filed Apr. 12, 2001. These prior applications, including the entire written descriptions and drawing figures, are hereby incorporated into the present application by reference.

### BACKGROUND

1. Field of the Invention

This invention generally relates to digital hearing instruments. More specifically, the invention provides a method in a digital hearing instrument for in-situ modeling of the instrument transducers (i.e., microphone(s) and speaker(s)) using the digital hearing instrument as a signal processor.

2. Description of the Related Art

Digital hearing instruments are known in this field. These instruments typically include a plurality of transducers, including at least one microphone and at least one speaker. Some instruments include a plurality of microphones, such as a front microphone and a rear microphone to provide directional hearing.

Hearing aid fitting software is often used during the customization of such instruments in order to configure the instrument settings for a particular user. This software typically presents information regarding the instrument to the fitting operator in the form of graphs displayed on a personal computer. The graphs are intended to display the performance of the instrument given the current settings of the device. In order to display these performance graphs, the fitting software requires mathematical models of the electrical transfer function of the instrument in conjunction with electro-acoustical models of the microphone and the speaker.

Traditionally, the electro-acoustical models of the microphone and the speaker are derived independently from the fitting process by skilled technicians. FIG. 2 is a block diagram showing the traditional method of characterizing a microphone in a digital hearing instrument. Here, the microphone-under-test (MUT) is coupled to a meter 108 for measuring the voltage output from the microphone. This measured voltage is applied to a custom test and measurement system 104, which is also coupled to a tone generator 106 and an external speaker 110. Operationally, the test and measurement system 104 controls the tone generator 106 and causes it to sweep across a particular frequency range of interest, during which time it takes measurement data from the meter 108. The test an measurement system then derives an electro-acoustical model 112 of the MUT 102 using the data gathered from the meter 108.

FIG. 3 is a block diagram showing the traditional method of characterizing a speaker in a digital hearing instrument. Here, the speaker-under-test (SUT) is coupled to the tone generator 106. The test and measurement system 104 causes the tone generator 106 to drive the SUT with a known signal level while the acoustic sound pressure developed from the SUT is quantified by a test microphone 102 and level meter 108. Using the data gathered from the level meter 108, the test and measurement system 104 then derives the electro-acoustical model for the SUT 110.

The problem with the foregoing traditional characterization and modeling methods is that the specialized equipment required to derive the models, i.e., the test and measurement system 104 and other equipment, is very expensive, and also requires a skilled technical operator.

### BRIEF DESCRIPTION OF THE DRAWINGS

FIG. 1 is a block diagram of an exemplary digital hearing instrument including a plurality of transducers;

FIG. 2 is a block diagram showing the traditional method of characterizing a microphone in a digital hearing instrument;

FIG. 3 is a block diagram showing the traditional method of characterizing a speaker in a digital hearing instrument;

FIG. 4 is a block diagram showing a method of in-situ transducer modeling according to the present invention; and

FIG. 5 is a block diagram showing another method of in-situ transducer modeling according to the present invention.

### SUMMARY

A method for in-situ transducer modeling in a digital hearing instrument is provided. In one embodiment, a personal computer is coupled to a processing device in the digital hearing instrument and configures the processing device to operate as a level detector and an internal tone generator. An audio signal generated by the personal computer is received by a microphone-under-test (MUT) in the digital hearing instrument and the energy level of the received audio signal is determined by the level detector. In addition, an audio output signal generated by the tone generator and a speaker-under-test (SUT) in the digital hearing instrument is received by a microphone, and the energy level of the audio output signal is determined by a level meter. The energy levels of the received audio signal and the audio output signal are used by the personal computer to generate an electro-acoustic model of the digital hearing instrument.

In another embodiment, the personal computer configures the processing device in the digital hearing instrument to operate as a level detector. An audio signal generated by the personal computer is received by a MUT in the digital hearing instrument, and the energy level of the received audio signal is determined by the level detector. A gain is then applied to the received audio signal, and the energy level of the amplified audio signal is determined by the level detector. The personal computer compares the energy levels of the received and amplified audio signals and adjusts the gain such that the digital hearing instrument meets predetermined hearing aid characteristics.

### DETAILED DESCRIPTION OF THE DRAWINGS

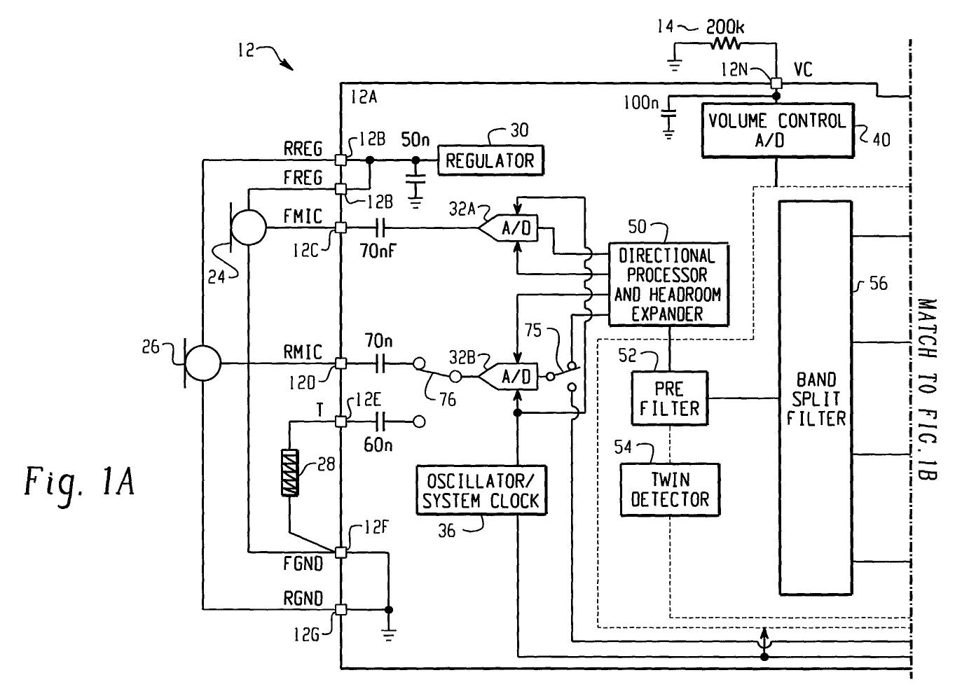

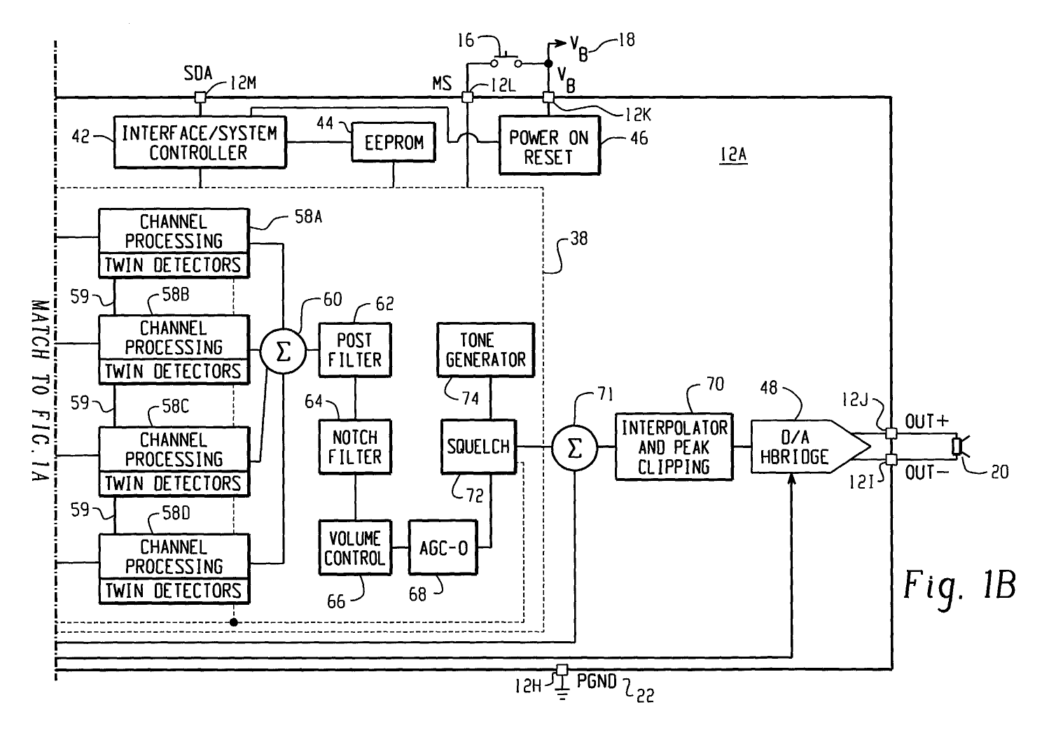

Turning now to the drawing figures, FIG. 1 is a block diagram of an exemplary digital hearing aid system 12. The digital hearing aid system 12 includes several external components 14, 16, 18, 20, 22, 24, 26, 28, and, preferably, a single integrated circuit (IC) 12A. The external components include a pair of microphones 24, 26, a tele-coil 28, a volume control potentiometer 24, a memory-select toggle switch 16, battery terminals 18, 22, and a speaker 20.

Sound is received by the pair of microphones 24, 26, and converted into electrical signals that are coupled to the FMIC 12C and RMIC 12D inputs to the IC 12A. FMIC refers to “front microphone,” and RMIC refers to “rear microphone.” The microphones 24, 26 are biased between a regulated voltage output from the RREG and FREG pins 12B, and the ground nodes FGND 12F and RGND 12G. The regulated voltage output on FREG and RREG is generated internally to the IC 12A by regulator 30.

The tele-coil 28 is a device used in a hearing aid that magnetically couples to a telephone handset and produces an input current that is proportional to the telephone signal. This input current from the tele-coil 28 is coupled into the rear microphone A/D converter 32B on the IC 12A when the switch 76 is connected to the “T” input pin 12E, indicating that the user of the hearing aid is talking on a telephone. The tele-coil 28 is used to prevent acoustic feedback into the system when talking on the telephone.

The volume control potentiometer 14 is coupled to the volume control input 12N of the IC. This variable resistor is used to set the volume sensitivity of the digital hearing aid.

The memory-select toggle switch 16 is coupled between the positive voltage supply VB 18 and the memory-select input pin 12L. This switch 16 is used to toggle the digital hearing aid system 12 between a series of setup configurations. For example, the device may have been previously programmed for a variety of environmental settings, such as quiet listening, listening to music, a noisy setting, etc. For each of these settings, the system parameters of the IC 12A may have been optimally configured for the particular user. By repeatedly pressing the toggle switch 16, the user may then toggle through the various configurations stored in the read-only memory 44 of the IC 12A.

The battery terminals 12K, 12H of the IC 12A are preferably coupled to a single 1.3 volt zinc-air battery. This battery provides the primary power source for the digital hearing aid system.

The last external component is the speaker 20. This element is coupled to the differential outputs at pins 12J, 121 of the IC 12A, and converts the processed digital input signals from the two microphones 24, 26 into an audible signal for the user of the digital hearing aid system 12.

There are many circuit blocks within the IC 12A. Primary sound processing within the system is carried out by a sound processor 38 and a directional processor and headroom expander 50. A pair of A/D converters 32A, 32B are coupled between the front and rear microphones 24, 26, and the directional processor and headroom expander 50, and convert the analog input signals into the digital domain for digital processing. A single D/A converter 48 converts the processed digital signals back into the analog domain for output by the speaker 20. Other system elements include a regulator 30, a volume control A/D 40, an interface/system controller 42, an EEPROM memory 44, a power-on reset circuit 46, a oscillator/system clock 36, a summer 71, and an interpolator and peak clipping circuit 70.

The sound processor 38 preferably includes a pre-filter 52, a wide-band twin detector 54, a band-split filter 56, a plurality of narrow-band channel processing and twin detectors 58A-58D, a summation block 60, a post filter 62, a notch filter 64, a volume control circuit 66, an automatic gain control output circuit 68, a squelch circuit 72, and a tone generator 74.

Operationally, the digital hearing aid system 12 processes digital sound as follows. Analog audio signals picked up by the front and rear microphones 24, 26 are coupled to the front and rear A/D converters 32A, 32B, which are preferably Sigma-Delta modulators followed by decimation filters that convert the analog audio inputs from the two microphones into equivalent digital audio signals. Note that when a user of the digital hearing aid system is talking on the telephone, the rear A/D converter 32B is coupled to the tele-coil input “T” 12E via switch 76. Both the front and rear A/D converters 32A, 32B are clocked with the output clock signal from the oscillator/system clock 36 (discussed in more detail below). This same output clock signal is also coupled to the sound processor 38 and the D/A converter 48.

The front and rear digital sound signals from the two A/D converters 32A, 32B are coupled to the directional processor and headroom expander 50. The rear A/D converter 32B is coupled to the processor 50 through switch 75. In a first position, the switch 75 couples the digital output of the rear A/D converter 32 B to the processor 50, and in a second position, the switch 75 couples the digital output of the rear A/D converter 32B to summation block 71 for the purpose of compensating for occlusion.

Occlusion is the amplification of the users own voice within the ear canal. The rear microphone can be moved inside the ear canal to receive this unwanted signal created by the occlusion effect. The occlusion effect is usually reduced by putting a mechanical vent in the hearing aid. This vent, however, can cause an oscillation problem as the speaker signal feeds back to the microphone(s) through the vent aperture. Another problem associated with traditional venting is a reduced low frequency response (leading to reduced sound quality). Yet another limitation occurs when the direct coupling of ambient sounds results in poor directional performance, particularly in the low frequencies. The system shown in FIG. 1 solves these problems by canceling the unwanted signal received by the rear microphone 26 by feeding back the rear signal from the A/D converter 32B to summation circuit 71. The summation circuit 71 then subtracts the unwanted signal from the processed composite signal to thereby compensate for the occlusion effect.

The directional processor and headroom expander 50 includes a combination of filtering and delay elements that, when applied to the two digital input signals, form a single, directionally-sensitive response. This directionally-sensitive response is generated such that the gain of the directional processor 50 will be a maximum value for sounds coming from the front microphone 24 and will be a minimum value for sounds coming from the rear microphone 26.

The headroom expander portion of the processor 50 significantly extends the dynamic range of the A/D conversion, which is very important for high fidelity audio signal processing. It does this by dynamically adjusting the operating points of the A/D converters 32A/32B. The headroom expander 50 adjusts the gain before and after the A/D conversion so that the total gain remains unchanged, but the intrinsic dynamic range of the A/D converter block 32A/32B is optimized to the level of the signal being processed.

The output from the directional processor and headroom expander 50 is coupled to the pre-filter 52 in the sound processor 38, which is a general-purpose filter for pre-conditioning the sound signal prior to any further signal processing steps. This “pre-conditioning” can take many forms, and, in combination with corresponding “post-conditioning” in the post filter 62, can be used to generate special effects that may be suited to only a particular class of users. For example, the pre-filter 52 could be configured to mimic the transfer function of the user's middle ear, effectively putting the sound signal into the “cochlear domain.” Signal processing algorithms to correct a hearing impairment based on, for example, inner hair cell loss and outer hair cell loss, could be applied by the sound processor 38. Subsequently, the post-filter 62 could be configured with the inverse response of the pre-filter 52 in order to convert the sound signal back into the “acoustic domain” from the “cochlear domain.” Of course, other pre-conditioning/post-conditioning configurations and corresponding signal processing algorithms could be utilized.

The pre-conditioned digital sound signal is then coupled to the band-split filter 56, which preferably includes a bank of filters with variable comer frequencies and pass-band gains. These filters are used to split the single input signal into four distinct frequency bands. The four output signals from the band-split filter 56 are preferably in-phase so that when they are summed together in summation block 60, after channel processing, nulls or peaks in the composite signal (from the summation block) are minimized.

Channel processing of the four distinct frequency bands from the band-split filter 56 is accomplished by a plurality of channel processing/twin detector blocks 58A-58D. Although four blocks are shown in FIG. 1, it should be clear that more than four (or less than four) frequency bands could be generated in the band-split filter 56, and thus more or less than four channel processing/twin detector blocks 58 may be utilized with the system.

Each of the channel processing/twin detectors 58A-58D provide an automatic gain control (“AGC”) function that provides compression and gain on the particular frequency band (channel) being processed. Compression of the channel signals permits quieter sounds to be amplified at a higher gain than louder sounds, for which the gain is compressed. In this manner, the user of the system can hear the full range of sounds since the circuits 58A-58D compress the full range of normal hearing into the reduced dynamic range of the individual user as a function of the individual user's hearing loss within the particular frequency band of the channel.

The channel processing blocks 58A-58D can be configured to employ a twin detector average detection scheme while compressing the input signals. This twin detection scheme includes both slow and fast attack/release tracking modules that allow for fast response to transients (in the fast tracking module), while preventing annoying pumping of the input signal (in the slow tracking module) that only a fast time constant would produce. The outputs of the fast and slow tracking modules are compared, and the compression parameters are then adjusted accordingly. The compression ratio, channel gain, lower and upper thresholds (return to linear point), and the fast and slow time constants (of the fast and slow tracking modules) can be independently programmed and saved in memory 44 for each of the plurality of channel processing blocks 58A-58D.

FIG. 1 also shows a communication bus 59, which may include one or more connections for coupling the plurality of channel processing blocks 58A-58D. This inter-channel communication bus 59 can be used to communicate information between the plurality of channel processing blocks 58A-58D such that each channel (frequency band) can take into account the “energy” level (or some other measure) from the other channel processing blocks. Preferably, each channel processing block 58A-58D would take into account the “energy” level from the higher frequency channels. In addition, the “energy” level from the wide-band detector 54 may be used by each of the relatively narrow-band channel processing blocks 58A-58D when processing their individual input signals.

After channel processing is complete, the four channel signals are summed by summation bock 60 to form a composite signal. This composite signal is then coupled to the post-filter 62, which may apply a post-processing filter function as discussed above. Following post-processing, the composite signal is then applied to a notch-filter 64, that attenuates a narrow band of frequencies that is adjustable in the frequency range where hearing aids tend to oscillate. This notch filter 64 is used to reduce feedback and prevent unwanted “whistling” of the device. Preferably, the notch filter 64 may include a dynamic transfer function that changes the depth of the notch based upon the magnitude of the input signal.

Following the notch filter 64, the composite signal is coupled to a volume control circuit 66. The volume control circuit 66 receives a digital value from the volume control A/D 40, which indicates the desired volume level set by the user via potentiometer 14, and uses this stored digital value to set the gain of an included amplifier circuit.

From the volume control circuit, the composite signal is coupled to the AGC-output block 68. The AGC-output circuit 68 is a high compression ratio, low distortion limiter that is used to prevent pathological signals from causing large scale distorted output signals from the speaker 20 that could be painful and annoying to the user of the device. The composite signal is coupled from the AGC-output circuit 68 to a squelch circuit 72, that performs an expansion on low-level signals below an adjustable threshold. The squelch circuit 72 uses an output signal from the wide-band detector 54 for this purpose. The expansion of the low-level signals attenuates noise from the microphones and other circuits when the input S/N ratio is small, thus producing a lower noise signal during quiet situations. Also shown coupled to the squelch circuit 72 is a tone generator block 74, which is included for calibration and testing of the system.

The output of the squelch circuit 72 is coupled to one input of summation block 71. The other input to the summation bock 71 is from the output of the rear A/D converter 32B, when the switch 75 is in the second position. These two signals are summed in summation block 71, and passed along to the interpolator and peak clipping circuit 70. This circuit 70 also operates on pathological signals, but it operates almost instantaneously to large peak signals and is high distortion limiting. The interpolator shifts the signal up in frequency as part of the D/A process and then the signal is clipped so that the distortion products do not alias back into the baseband frequency range.

The output of the interpolator and peak clipping circuit 70 is coupled from the sound processor 38 to the D/A H-Bridge 48. This circuit 48 converts the digital representation of the input sound signals to a pulse density modulated representation with complimentary outputs. These outputs are coupled off-chip through outputs 12J, 12I to the speaker 20, which low-pass filters the outputs and produces an acoustic analog of the output signals. The D/A H-Bridge 48 includes an interpolator, a digital Delta-Sigma modulator, and an H-Bridge output stage. The D/A H-Bridge 48 is also coupled to and receives the clock signal from the oscillator/system clock 36 (described below).

The interface/system controller 42 is coupled between a serial data interface pin 12M on the IC 12, and the sound processor 38. This interface is used to communicate with an external controller for the purpose of setting the parameters of the system. These parameters can be stored on-chip in the EEPROM 44. If a “black-out” or “brown-out” condition occurs, then the power-on reset circuit 46 can be used to signal the interface/system controller 42 to configure the system into a known state. Such a condition can occur, for example, if the battery fails.

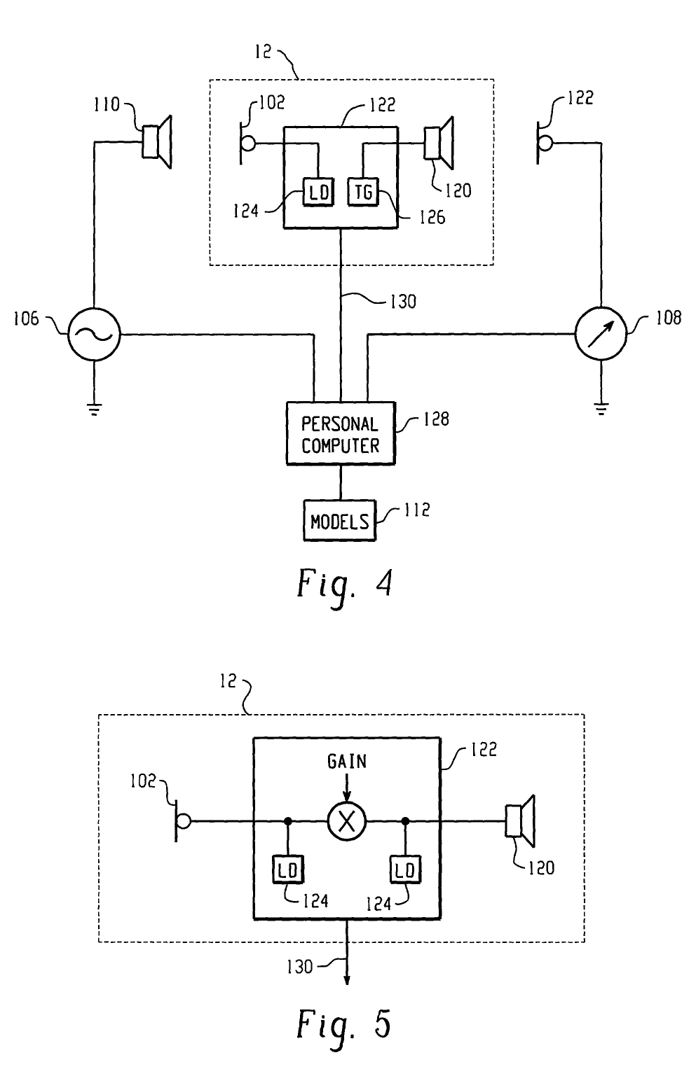

FIG. 4 is a block diagram showing a method of in-situ transducer modeling according to one embodiment of the present invention. Here, instead of the specialized test and measurement system 104 used in the traditional characterization and modeling methods, a personal computer 128 is substituted. The personal computer 128 is coupled to a tone generator 106 and a level meter 108. The personal computer 128 is also coupled to the digital hearing instrument 12 via an external port connection 130, such as a serial port.

Within the digital hearing instrument is the microphone-under-test (MUT) 102 and the speaker-under-test (SUT) 120. Also included in the digital hearing instrument is a processing device, such as a programmable digital signal processor (DSP) 122. This processing device 122 may be similar to sound processor 38 shown in FIG. 1.

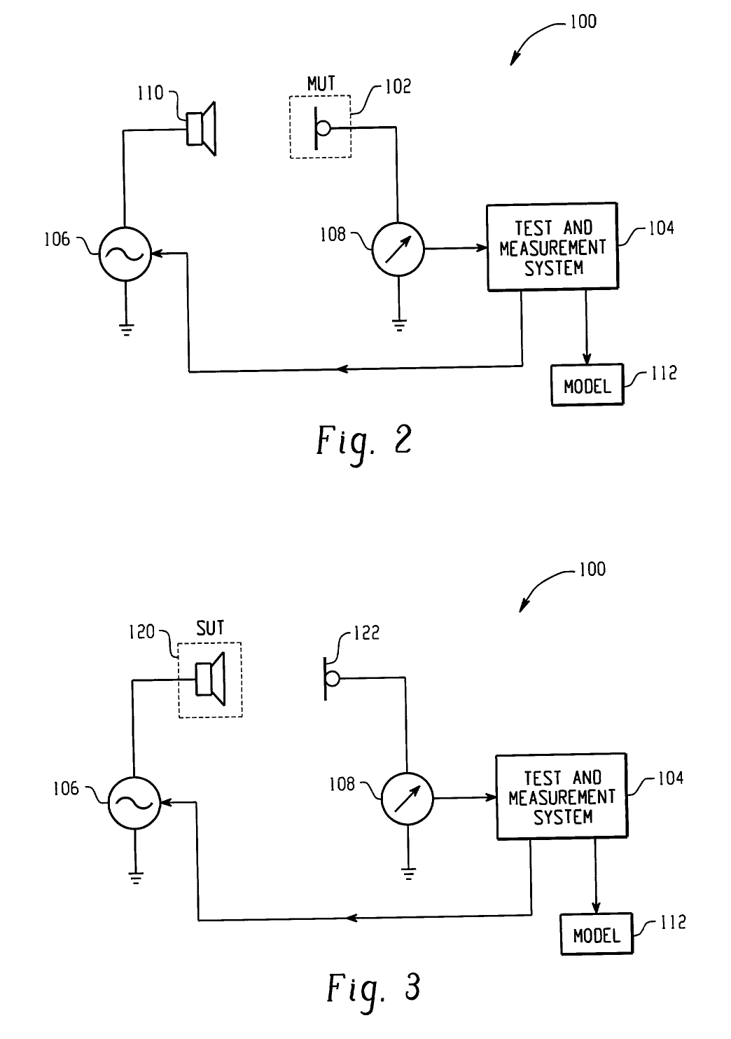

Software operating on the personal computer 128 configures the DSP 122 to operate as a level detector (LD) 124 for incoming MUT 102 signals, and as an internal tone generator (TG) 126 for the SUT 120. This software then performs the required frequency sweep measurements using the external speaker 110 and the MUT/LD combination 102/124 within the digital hearing instrument 12. The software also performs the frequency sweep of the TG/SUT combination 126/120 and measures with the external microphone 122 and level meter 108. By configuring the DSP 122 in this manner, the personal computer can replace the more complicated test and measurement system 104 shown in FIGS. 2 and 3, and enables a non-skilled operator to generate the electro-acoustic models 112 of the digital hearing instrument 12.

FIG. 5 is a block diagram showing another method of in-situ transducer modeling according to the present invention. In this method, the processing device 122 does not include a tone generator (TG) 126. Instead, the TG 126 function is achieved by using the external speaker 110 transduced by the MUT 102, and by adjusting the gain of the circuit so that the signal level presented to the SUT 120, and measured by an additional level detector 124, meets the pre-determined hearing instrument characteristics. Again, the software operating at the personal computer 128 performs the desired frequency sweep with the additional step of adjusting the gain at each frequency step.

This written description uses examples to disclose the invention, including the best mode, and also to enable any person skilled in the art to make and use the invention. The patentable scope of the invention is defined by the claims, and may include other examples that occur to those skilled in the art.

I claim:

1. A method of in-situ transducer modeling in a digital hearing instrument, comprising the steps of:
providing a microphone-under-test (MUT) coupled to a level detector in the digital hearing instrument;
generating an audio signal using a personal computer coupled to a tone generator;
receiving the audio signal with the MUT in the digital hearing instrument;
determining the energy level of the received audio signal using the level detector in the digital hearing instrument;
coupling the personal computer to the level detector through an external port connection in the digital hearing instrument;
recording the energy level of the received audio signal with the personal computer; and
developing an electro-acoustic model of the digital hearing instrument using the recorded energy level of the received audio signal.

2. The method of claim 1, comprising the additional step of:
configuring a processing device in the digital hearing instrument to operate as the level detector.

3. The method of claim 1, comprising the additional steps of:
providing a speaker-under-test (SUT) coupled to an internal tone generator in the digital hearing instrument;
generating an audio output signal with the internal tone generator and SUT;
receiving the audio output signal with a microphone;
determining the energy level of the audio output signal with a level meter;
recording the energy level of the audio output signal with the personal computer; and
developing the electro-acoustic model of the digital hearing instrument using the recorded energy level of the audio output signal.

4. The method of claim 3, comprising the additional steps of:
coupling the personal computer to a processing device in the digital hearing instrument; and
configuring the processing device in the digital hearing instrument to operate as the internal tone generator.

5. A method of in-situ transducer modeling in a digital hearing instrument, comprising the steps of:
a microphone-under-test (MUT) and a speaker-under-test (SUT) in the digital hearing instrument;
generating an audio signal using a personal computer coupled to a tone generator;
receiving the audio signal with the MUT;
coupling the personal computer to a processing device in the digital hearing instrument;
configuring the processing device to operate as a level detector;
determining the energy level of the received audio signal using the level detector;
applying a gain to the received audio signal to generate an amplified audio signal;
determining the energy level of the amplified audio signal using the level detector;
using the personal computer to determine a difference between the energy levels of the received and amplified audio signals;
determining if the difference between the energy levels of the received and amplified audio signals meets a pre-determined hearing aid characteristic; and
if the difference between the energy levels of the received and amplified audio signals does not meet the predetermined hearing aid characteristic, then adjusting the gain applied to the received audio signal.
